(19) United States
(12) Patent Application Publication
(10) Pub. No.: US 2010/0078288 A1
(43) Pub. Date: Apr. 1, 2010

(54) TRANSMISSION SWITCHING ELEMENT

(75) Inventors: Kai HEINRICH, Waldburg (DE); Michael PANTKE, Friedrichshafen (DE); Stefan ALBRECHT, Leutkirch (DE); Henrik SCHUH, Friedrichshafen (DE); Reiner KELLER, Ludwigshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/632,077

(22) Filed: Dec. 7, 2009

(30) Foreign Application Priority Data
Dec. 15, 2005 (DE) 10-2008 054 668.2

(51) Int. Cl. F16H 57/10

(52) U.S. Cl. 192/220

(57) ABSTRACT

An electromagnetically actuated transmission shifting element of a motor vehicle, in particular an electromagnetically actuated transmission brake (1), having a disk packet (3) and an electromagnetic actuator (7, 8, 9) for adjustable compression, to a greater or lesser extent, of the disk packet (3) and with at least one speed sensor (10). Each at least one speed sensor is integrated in the electromagnetic actuator.

This application claims priority from German patent application serial no. 10 2008 054 668.2 filed Dec. 15, 2008.

### FIELD OF THE INVENTION

The invention concerns an electromagnetically actuated transmission shifting element, in particular for an electromagnetically actuated transmission brake.

### BACKGROUND OF THE INVENTION

An electromagnetically actuated transmission brake for a motor vehicle is known from DE 102 58 505 A1. The transmission brake disclosed therein has a disk packet such that a set of first disks of the disk packet are associated with a transmission shaft to be braked, and a set of second disks of the disk packet are associated with a fixed housing. Besides the disk packet, the transmission brake, known from this prior art, also comprises an electromagnetic actuator whose purpose is to compress the disk packet, to a greater or lesser extent, and thereby bring about a defined braking of the transmission shaft. The electromagnetic actuator of the transmission brake comprises an annular coil and an annular armature such that, when the annular coil is energized, a magnetic field is built up which acts on the annular armature. In addition, the transmission brake known from this prior art has a rotational speed sensor which co-operates with a signal-emitter wheel so that, with the help of the said speed sensor and emitter wheel, the speed of the transmission shaft to be braked can be detected in order thereby to control or regulate the braking of the shaft. According to DE 102 58 505 A1, the emitter wheel can be associated with the transmission shaft to be braked. The speed sensor constitutes a separate, independent structural group.

### SUMMARY OF THE INVENTION

Starting from this, the present invention addresses the problem of providing a new type of electromagnetically actuated transmission shifting element.

According to the invention the, or each speed sensor is integrated in the electromagnetic actuator.

According to the present invention, the speed sensor is integrated in the electromagnetic actuator of the electromagnetically actuated transmission brake. Preferably, the speed sensor is integrated in a magnet body which also holds the coil, or all the coils of the electromagnetic actuator. This then makes it possible to combine electric connections for the coil or coils and for the speed sensor. Thereby, a simpler and more compact structure is obtained and the transmission shifting element can be produced with less assembly effort.

### BRIEF DESCRIPTION OF THE DRAWING

Preferred further developments of the invention emerge from the subordinate claims and from the description given below. An example embodiment of the invention, to which it is not limited, is explained in more detail with reference to the drawing which shows:

FIG. 1 a greatly simplified representation of an electromagnetically actuated transmission shifting element according to the invention.

### DETAILED DESCRIPTION OF THE PREFERRED EMBODIMENTS

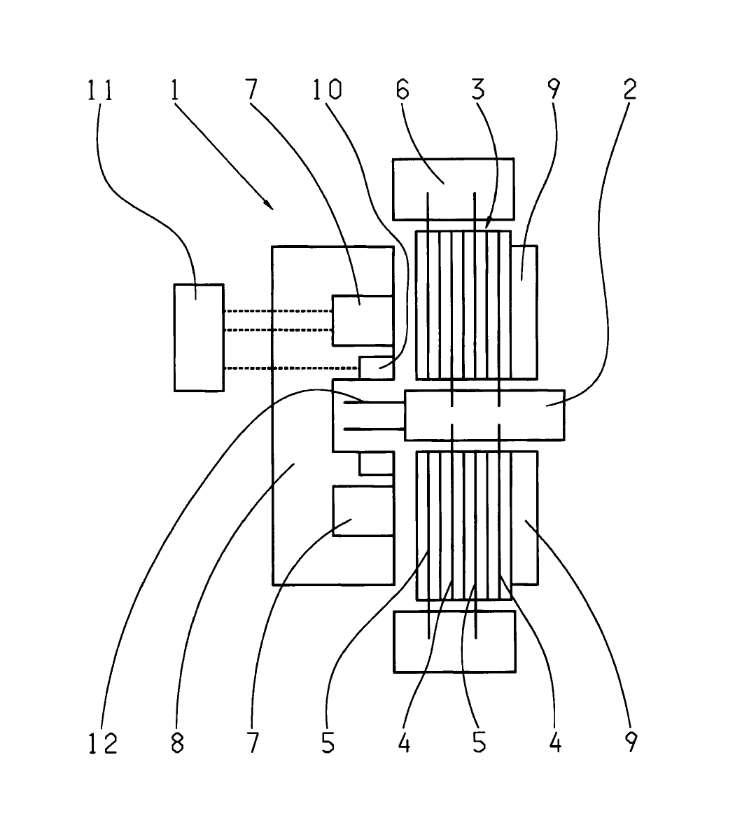

FIG. 1 shows a schematic representation of a preferred example embodiment of an electromagnetically actuated transmission shifting element in the form of a transmission brake 1. The transmission brake 1, shown in FIG. 1, is used for the defined braking of a shaft 2 of a motor vehicle transmission, the shaft 2 being in particular a so-called countershaft of the motor vehicle transmission.

The electromagnetically actuated transmission brake 1 comprises a disk packet 3 having a plurality of disks, namely, a set of first disks 4 associated with the transmission shaft 2 to be braked and a set of second disks 5 associated with a stator-side housing 6 of the transmission brake 1.

With the help of an electromagnetic actuator, the disks 4, 5 of the disk packet 3 can be adjustably compressed together, to a greater or lesser extent, so as to brake the transmission shaft 2 more intensely or less so.

The electromagnetic actuator of the transmission brake 1 comprises at least one coil 7, integrated in a magnet body 8, and an armature 9 so that when the coil 7 is energized, an electromagnetic field is built up which acts upon the armature 9 in such manner that, depending on the strength of the magnetic field, the disk packet 3 of the transmission brake is compressed more, or less.

To control or regulate operation of the transmission brake 1, the brake comprises a speed sensor 10 by which the rotational speed of the transmission shaft 2, to be braked, can be detected by measurement-technological means.

In the context of the present invention, the speed sensor 10 that serves to determine, by measurement means, the speed of the transmission shaft 2 to be braked is integrated in the electromagnetic actuator, namely, in the case of the preferred example embodiment illustrated in FIG. 1, it is integrated in the magnet body 8 of the actuator which also holds the coil 7. Thus, electrical connections for the coil 7 and for the speed sensor 10, by means of which they can be connected to a control device 11, can be combined in a single unit. In FIG. 1, the signal leads which connect the coil 7 and the speed sensor 10 to the control device 11 are represented as dotted lines.

A signal-emitter wheel 12 which, in the example embodiment of FIG. 1 is associated with the transmission shaft 2 to be braked, co-operates with the speed sensor 10.

In the said example embodiment of FIG. 1, the emitter wheel 12 moves past a surface of the speed sensor 10 that extends parallel to the rotation axis of the shaft 2 to be braked. In FIG. 1, therefore, the speed of the transmission shaft 2 to be braked is detected radially by the speed sensor 10.

As an alternative to the example embodiment shown, the emitter wheel 12 could also move past a surface of the speed sensor 10 extending perpendicularly to the rotational axis of the transmission shaft 2 to be braked. In that case, the speed of the transmission shaft 2 to be braked would be detected axially.

In another alternative to the example embodiment illustrated in FIG. 1, the emitter wheel 12 could be associated not with the transmission shaft 2, but instead with the disk packet 3, namely, with the first disks 4 of the disk packet 3 which are associated with the transmission shaft 2 to be braked.

It is preferable to use a sensor that operates using a differential measurement principle, for example, a differential Hall sensor as the speed sensor 10. A magnetic bias can be imposed on the speed sensor 10 by the energizing field of the coil 7.

The magnet body 8 can, in particular, be integrated in the housing 6 or connected permanently to it, or made integrally with the housing 6, in order to make the transmission shifting element particularly compact.

Although the present invention has been described with reference to FIG. 1, which relates to the example of a transmission brake, the invention can also be used with a transmission clutch. In the case of a transmission clutch, the speeds of two rotating shafts have to be adapted to one another so with a transmission clutch first disks of a disk packet of a first rotating shaft and second disks of a disk packet of a second rotating shaft are associated.

Since, in this case, the speeds of two shafts have to be detected, two speed sensors are needed which, in turn, in accordance with the invention, are integrated in the electromagnetic actuator by means of which the disk packet can be compressed. The two speed sensors each co-operate with an emitter wheel associated, in each case, with the respective shaft or disk packet.

### INDEXES

1 Transmission brake
2 Transmission shaft
3 Disk packet
4 First disks
5 Second disks
6 Housing
7 Coil
8 Magnet body
9 Armature
10 Speed sensor
11 Control device
12 Emitter wheel

1-7. (canceled)

8. An electromagnetically actuated transmission shifting element of a motor vehicle comprising:
a disk packet (3) having an electromagnetic actuator (7, 8, 9) for adjusting a compression of the disk packet (3) to a greater or a lesser extent, and
at least one speed sensor (10),
wherein the at least one speed sensor is integrated in the electromagnetic actuator.

9. The transmission shifting element according to claim 8, wherein the electromagnetic actuator comprises a magnet body (8) holding at least one coil (7), and an armature (9), and the at least one speed sensor (10) is integrated together with the at least one coil (7) in the magnet body (8).

10. The transmission shifting element according to claim 8, wherein an emitter wheel (12), which co-operates with the at least one speed sensor (10), is associated with a shaft (2) to be braked.

11. The transmission shifting element according to claim 8, wherein an emitter wheel (12), which co-operates with the at least one speed sensor (10), is formed by disks of the disk packet (3) associated with a shaft (2) to be braked.

12. The transmission shifting element according to claim 10, wherein the speed sensor (10) detects the speed of the shaft (2) to be braked axially relative to the shaft (2) to be braked.

13. The transmission shifting element according to claim 10, wherein the speed sensor (10) detects the speed of the shaft (2) to be braked radially relative to the shaft (2) to be braked.

14. The transmission shifting element according to claim 8, wherein electrical connections for the at least one speed sensor (10) and for the at least one coil (7) are combined.

15. The transmission shifting element according to claim 8, wherein the electromagnetically actuated transmission shifting element is an electromagnetically actuated transmission brake (1).
